(19) United States
(12) Patent Application Publication
(10) Pub. No.: US 2008/0260619 A1
(43) Pub. Date: Oct. 23, 2008

(54) PROCESSES FOR THE OXIDATION OF HYDROGEN CHLORIDE

(75) Inventors: Knud Werner, Krefeld (DE); Lutz Gottschalk, Koln (DE); Meik Bernhard Franke, Koln (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/104,588

(22) Filed: Apr. 17, 2008

(30) Foreign Application Priority Data
Apr. 17, 2007 (DE) 102007018014.6

(51) Int. Cl. C01B 7/04

(52) U.S. Cl. 423/502

(57) ABSTRACT

A process for carrying out an optionally catalyst-assisted hydrogen chloride oxidation process by means of oxygen is described. The process comprises single- or multi-stage cooling of the process gases and separating off of unreacted hydrogen chloride and water of reaction from the process gas, drying of the product gases, separating off of chlorine from the mixture and recycling of the unreacted oxygen into the hydrogen chloride oxidation process, at least some of the heat content of the product gases being used for recovery of heat and at least some of the coldest gas streams being used for cooling in the process.

### BACKGROUND OF THE INVENTION

In many large-scale industrial chemical processes, such as the preparation of isocyanates, in particular MDI and TDI, and in chlorination processes of organic substances, chlorine is employed as a raw material and an HCl gas stream is produced as a by-product.

The following various processes which are known in principle are mentioned here by way of example of the production of chlorine and, in particular, the utilization of the HCl gas stream obtained, e.g. as an unavoidable product in an isocyanate production process.

The production of chlorine in NaCl electrolyses and utilization of HCl either by selling or by further processing in oxychlorination processes, e.g. in the preparation of vinyl chloride.

The conversion of HCl into chlorine by electrolysis of aqueous HCl with diaphragms or membranes as a separating medium between the anode and cathode chamber. The linked product here is hydrogen.

The conversion of HCl into chlorine by electrolysis of aqueous HCl in the presence of oxygen in electrolysis cells with an oxygen depletion cathode (ODC). The linked product here is water.

The conversion of HCl gas into chlorine by gas phase oxidation of HCl with oxygen at elevated temperatures over a catalyst. The linked product here is likewise water. Such a process (also known as the “Deacon process”) has been known and used as for more than a century.

All these processes have varying degrees of advantages for isocyanate preparation depending on the market conditions of the linked products (e.g. sodium hydroxide solution, hydrogen, vinyl chloride in the first case), the framework conditions at the particular location (e.g. energy prices, integration into a chlorine infrastructure) and the expenditure on investment and operating costs. The Deacon process, mentioned last, is becoming greater in importance.

### BRIEF SUMMARY OF THE INVENTION

The present invention relates, in general, to the recovery of heat in hydrogen chloride oxidation processes, such as, for example, in a Deacon process. More particularly, the present invention relates to processes for the catalytic oxidation of hydrogen chloride in the gas phase by means of oxygen. Such processes can comprise single- or multi-stage cooling of the process gases and separating off of reacted hydrogen chloride and water of reaction from the process gas, drying of the product gases, separating off of chlorine from the mixture and recycling of the unreacted oxygen into the hydrogen chloride oxidation process.

An object of the present invention is a reduction in the energy required to operate a Deacon process, where such a reduction is achieved by recovery of heat.

The present invention includes processes for the catalytic oxidation of hydrogen chloride with oxygen to give chlorine and water in the gas phase, characterized in that at least some of the heat content of the product gases is used for heating the educt gases.

One embodiment of the present invention includes a process comprising: providing a reaction gas comprising hydrogen chloride; and subjecting the reaction gas to catalytic oxidation with an oxygen-containing gas to form a product gas comprising chlorine and water, wherein heat is exchanged between at least a portion of the product gas and a portion of one or both of the reaction gas and the oxygen-containing gas.

Various embodiments of the present invention include processes for the catalytic oxidation of hydrogen chloride with oxygen to give chlorine and water, which processes can be combined, in particular, with the abovementioned process, wherein after the oxidation reaction, chlorine can be separated from the oxygen and, where appropriate, inert gases by liquification of the chlorine and removal of any inert gases present and the oxygen and subsequent vaporization of the chlorine formed, characterized in that at least some of the heat content of the reaction products of the oxidation is used for vaporization of the pure liquefied chlorine.

Various embodiments of the present invention include processes for the catalytic oxidation of hydrogen chloride with oxygen to give chlorine and water, which processes can be combined, in particular, with at least one of the abovementioned processes, in which chlorine is obtained from the product gases by liquification, where the liquid chlorine contains production-related amounts of carbon dioxide, and carbon dioxide is subsequently vaporized out of the liquefied chlorine, characterized in that at least some of the heat content of the product gases of the oxidation reaction is used for vaporization of the carbon dioxide out of the liquefied chlorine.

Various embodiments of the present invention include processes for the catalytic oxidation of hydrogen chloride with oxygen to give chlorine and water, which processes can be combined, in particular, with at least one of the abovementioned processes, in which chlorine is obtained from the product gases by liquification, the liquid chlorine containing production-related amounts of carbon dioxide, and carbon dioxide is subsequently vaporized out of the liquefied chlorine, characterized in that some of the chlorine vaporized with the carbon dioxide is condensed and the non-condensed cold gases are used for precooling the product gases before the liquification.

Various additional embodiments of the present invention include processes in which two or more of the above processes are combined with the initial catalytic oxidation of hydrogen chloride.

### BRIEF DESCRIPTION OF THE SEVERAL VIEWS OF THE DRAWING

The foregoing summary, as well as the following detailed description of the invention, may be better understood when read in conjunction with the appended drawings. For the purpose of assisting in the explanation of the invention, there are shown in the drawings representative embodiments which are considered illustrative. It should be understood, however, that the invention is not limited in any manner to the precise arrangements and instrumentalities shown.

In the drawings:

FIG. 1 is a flow diagram of a process according to one embodiment of the present invention;

FIG. 2 is a flow diagram of a process according to another embodiment of the present invention;

FIG. 3 is a flow diagram of a process according to another embodiment of the present invention;

FIG. 4 is a flow diagram of a process according to another embodiment of the present invention; and

FIG. 5 is a flow diagram of a comparative process for the catalytic oxidation of an HCl gas without any heat recovery measures of the present invention.

### DETAILED DESCRIPTION OF THE INVENTION

As used herein, the singular terms “a” and “the” are synonymous and used interchangeably with “one or more” and “at least one,” unless the language and/or context clearly indicates otherwise. Accordingly, for example, reference to “a gas” herein or in the appended claims can refer to a single gas or more than one gas. Additionally, all numerical values, unless otherwise specifically noted, are understood to be modified by the word “about.”

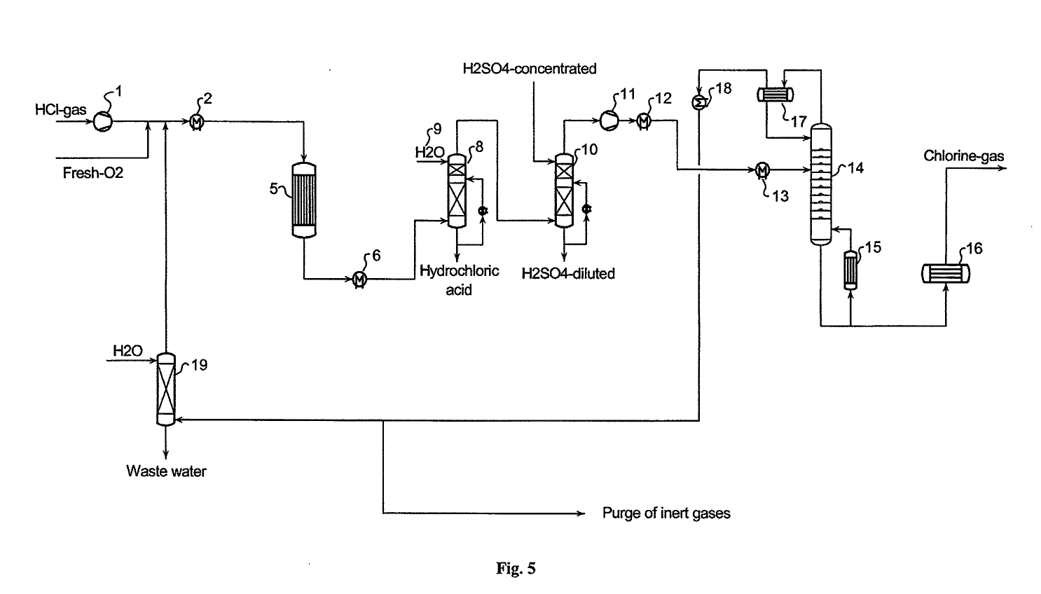

Referring, for example, to FIG. 5, for comparative discussion, the catalytic oxidation of an HCl gas with O₂ to give Cl₂ and H₂O is carried out under increased pressure at elevated temperature. For this, the HCl gas is compressed in compressor 1, fresh O₂ is fed in under pressure, and the mixture is heated in heater 2 and subsequently reacted in a reactor 5.

The reactor 5 can be operated isothermally or adiabatically. In the case of adiabatic operation, instead of a single reactor it is also possible to connect several reactors in series. Connection in series of up to 7 reactors is advantageous. Between the reactors, the heat of reaction can then be removed in intermediate coolers. Since this heat is obtained at high temperatures, it can expediently be employed for generation of steam. For this, the intermediate coolers can be fed directly with water, which vaporizes. As an alternative, a heat transfer medium, such as e.g. a fused salt, can also be employed. This heats up on absorbing the heat of reaction and can be used for vaporization of water in a separate apparatus.

The Cl₂ gas formed is freed from unreacted HCl, from the H₂O formed and from excess O₂. For this, HCl and H₂O are first removed by cooling in cooler 6 and washing in column 8 with water 9, and are discharged from the process as hydrochloric acid. Such cooling and washing is described, for example, in European Patent Publication No. EP 233 773, the entire contents of which are incorporated herein by reference.

Complete removal of the H₂O is typically effected by drying 10 with concentrated sulfuric acid.

Excess O₂ and inert gases are then separated off by condensation of the Cl₂ in condenser 13. For this, the pressure can first be increased in a compressor 11 so that the condensation does not have to be carried out at far too low temperatures. The condensed Cl₂ conventionally contains CO₂, which is removed from the liquid Cl₂ with a distillation/stripping column 14. The pure Cl₂ obtained in this way is subsequently vaporized again in evaporator 16 and used for further processes, such as, e.g. isocyanate production.

Excess O₂ and inert gases are recycled into the reactor, so that the expensive O₂ is not discarded.

Before the recycling into the reactor, inert gases are purged and the gas stream is purified from sulfur components, since under certain circumstances these poison the oxidation catalyst. Apparatuses which are typically used for this purpose are wash columns 19.

Carrying out the process requires both very high and very low temperatures. Thus, the catalytic oxidation typically takes place at temperatures of 300-500° C., while the condensation of the Cl₂ is carried out at temperatures significantly below 0° C.

The present inventors have discovered methods by which to carry out the catalytic oxidation of HCl gas economically, by linking of process streams to recover heat.

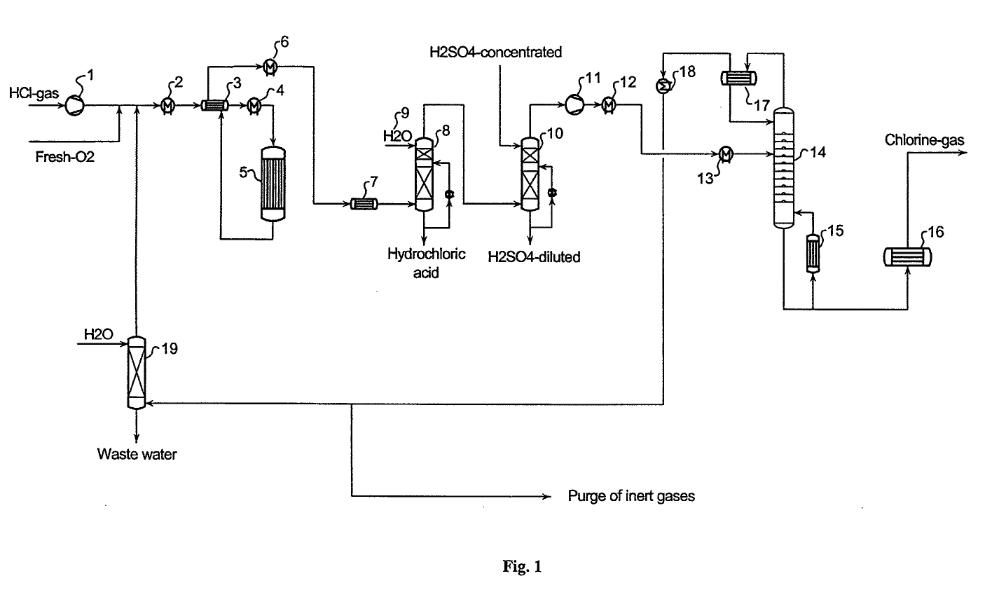

A first measure for recovery of heat uses the high temperature of the gas emerging from the reactor (i.e., the product gases) for heating the educts (i.e., the HCl gas and/or the oxygen-containing gas) entering into the reactor. Referring, for example, to FIG. 1, the product gas and the educt gases can be passed over the two sides of a heat exchanger 3 and cooled or, respectively, heated up. This measure can provide a large portion of the heat for heating the educts to the reaction temperature.

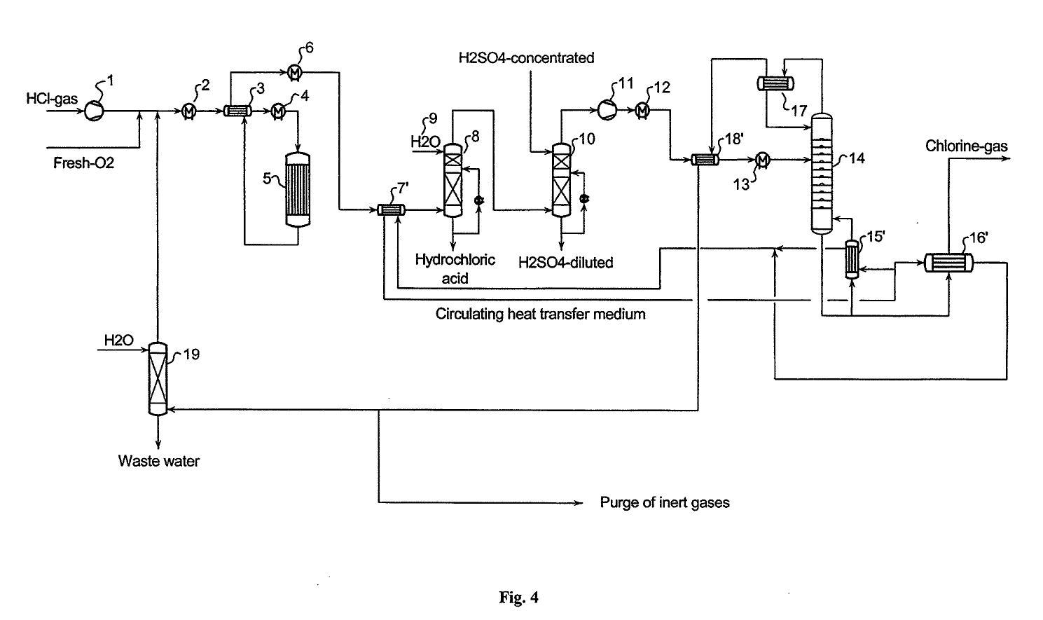

Unreacted HCl and the H₂O formed can be separated off by cooling and washing with water. For this, the temperature of the product gas stream cooled, e.g. in the context of the first measure for recovery of heat, is lowered further. Referring, for example, to FIG. 4, this additional cooling can be effected in a heat exchanger 7′, on the other side of which a heat transfer fluid is fed in and is heated to the extent that it can be used for heating other process streams. Water, steam, a thermal oil or other fluids suitable for this purpose can be employed as the heat transfer fluid. Such a process stream which can be heated in this manner is the pure, liquid Cl₂, which can be vaporized with hot heat transfer fluid in the evaporator 16′. A further suitable process stream flows through the reboiler 15′ of the distillation/stripping column 14 for removal of CO₂ from liquid Cl₂. Here also, hot heat transfer fluid can advantageously be employed for operating the reboiler.

A third measure for recovery of heat results from coupling of the product gas stream to the chlorine condensation and of the gas stream which emerges at the top of the distillation/stripping in a heat exchanger 18′ (see e.g. FIG. 4). The latter stream has the lowest temperature in the entire process and can therefore advantageously be used for precooling the product gas stream for the chlorine condensation.

German Patent Publication No. DE 3 436 139 (and its English counterpart U.S. Pat. No. 4,606,742), the entire contents of which are incorporated herein by reference, describes a recovery of heat in which hot flue gases are cooled in a waste heat boiler in which water is vaporized. The direct coupling of gases entering into the reaction chamber and emerging from it is not described. Such direct coupling has the advantage that no intermediate medium, such as e.g. water, has to be employed, which in principle allows a greater recovery of heat.

Japanese Patent Publication No. JP 2003-292304 and German Patent Publication No. DE 195 35 716 (and its English counterpart U.S. Pat. No. 6,387,345), the entire contents of which are incorporated herein by reference, describe a recovery of heat in the region of the distillation/stripping column for removal of CO₂ from liquid Cl₂. The bottom product stream of liquid, pure Cl₂ is expanded and then led into a heat exchanger, in which it is vaporized, and on the other side of the apparatus, it cools the stream entering into the column and condenses the Cl₂ contained in it. For heat recovery, this has the disadvantage that the pressure and the composition of both the condensing stream and the vaporizing stream must be closely matched to one another. Thus, JP 2003-292304 reports that the pressure of the stream entering into the column must be >6 bar at a content of >45 mol % Cl₂. A Cl₂ partial pressure of >2.7 bar corresponds to this. According to this patent, the pressure of the pure, liquid Cl₂ must be expanded to <3 bar. This is necessary, since otherwise no condensation of the gas stream entering into the column or vaporization of the liquid Cl₂ stream can take place. If the users of the vaporized Cl₂ stream are orientated towards pressures of >3 bar, this type of recovery of heat cannot be used.

In various embodiments according to the processes of the present invention, referring for example to FIG. 4, coupling of the cooler 7′ with the reboiler 15′ of the column 14 and the chlorine evaporator 16′ via a heat transfer fluid does not have this close linking. It is thus entirely possible for the heat transfer fluid to have temperatures of 80° C. and more. The Cl₂ vaporized with this can then reach at least temperatures of 60-70° C., which corresponds to a Cl₂ vapor pressure of between 17.8 and 21.8 bar.

The coupling according to various embodiments of the present invention of the top stream of the distillation/stripping column with its feed stream is also not described in the prior art processes.

The catalytic process known as the Deacon process can be cried out in particular as described in the following: hydrogen chloride is oxidized with oxygen in an exothermic equilibrium reaction to give chlorine and steam. The reaction temperature is conventionally 150 to 500° C. and the conventional reaction pressure is 1 to 25 bar. Since this is an equilibrium reaction, it is expedient to operate at the lowest possible temperatures at which the catalyst still has an adequate activity. It is furthermore expedient to employ oxygen in amounts which are in excess of stoichiometric amounts with respect to the hydrogen chloride. For example, a two- to four-fold oxygen excess is conventional. Since no losses in selectivity are to be feared, it may be of economic advantage to operate under a relatively high pressure and accordingly over a longer residence time compared with normal pressure.

Suitable preferred catalysts for the Deacon process contain ruthenium oxide, ruthenium chloride or other ruthenium compounds on silicon dioxide, aluminum oxide, titanium dioxide, tin dioxide or zirconium dioxide as a support. Suitable catalysts can be obtained, for example, by application of ruthenium chloride to the support and subsequent drying or by drying and calcining. Suitable catalysts can also contain, in addition to or instead of a ruthenium compound, compounds of other noble metals, for example gold, palladium, platinum, osmium, iridium, silver, copper or rhenium. Suitable catalysts can furthermore contain chromium (III) oxide.

The catalytic hydrogen chloride oxidation can be carried out adiabatically or, preferably, isothermally or approximately isothermally, discontinuously, but preferably continuously as a fluidized or fixed bed process, preferably as a fixed bed process, particularly preferably in tube bundle reactors over heterogeneous catalysts at a reaction temperature of from 180 to 500° C., preferably 200 to 400° C., particularly preferably 220 to 380° C. and under a pressure of from 1 to 25 bar (1,000 to 25,000 hPa), preferably 1.2 to 20 bar, particularly preferably 1.5 to 17 bar and in particular 2.0 to 15 bar.

Conventional reaction apparatuses in which the catalytic hydrogen chloride oxidation is carried out are fixed bed or fluidized bed reactors. The catalytic hydrogen chloride oxidation can preferably also be carried out in several stages.

In the adiabatic, the isothermal or approximately isothermal procedure, several, that is to say 2 to 10, preferably 2 to 8, particularly preferably 4 to 8, in particular 5 to 8 reactors connected in series with intermediate cooling can also be employed. The hydrogen chloride can be added either completely together with the oxygen before the first reactor, or distributed over the various reactors. In a preferred variant, the oxygen is led completely before the first reactor and the hydrogen chloride is added distributed over the various reactors. This connection of individual reactors in series can also be combined in one apparatus.

A further preferred embodiment of a device which is suitable for the process comprises employing a structured bulk catalyst in which the catalyst activity increases in the direction of flow. Such a structuring of the bulk catalyst can be effected by different impregnation of the catalyst support with the active composition or by different dilution of the catalyst with an inert material. Rings, cylinders or balls of titanium dioxide, zirconium dioxide or mixtures thereof, aluminum oxide, steatite, ceramic, glass, graphite, stainless steel or nickel alloys can be employed, for example, as the inert material. In the case of the preferred use of shaped catalyst bodies, the inert material should preferably have similar external dimensions.

Suitable shaped catalyst bodies are shaped bodies having any desired shape, preferred shapes being lozenges, rings, cylinders, stars, cart-wheels or spheres and particularly preferred shapes being rings, cylinders or star-shaped extrudates.

Suitable heterogeneous catalysts are, in particular, ruthenium compounds or copper compounds on support materials, which can also be doped, optionally doped ruthenium catalysts being preferred. Suitable support materials are, for example, silicon dioxide, graphite, titanium dioxide having the rutile or anatase structure, zirconium dioxide, aluminum oxide or mixtures thereof, preferably titanium dioxide, zirconium dioxide, aluminum oxide or mixtures thereof, particularly preferably γ- or δ-aluminum oxide or mixtures thereof.

The copper or the ruthenium supported catalysts can be obtained, for example, by impregnation of the support material with aqueous solutions of CuCl₂ or RuCl₃ and optionally a promoter for doping, preferably in the form of their chlorides. The shaping of the catalyst can be carried out after or, preferably, before the impregnation of the support material.

Suitable promoters for doping of the catalysts are alkali metals, such as lithium, sodium, potassium, rubidium and cesium, preferably lithium, sodium and potassium, particularly preferably potassium, alkaline earth metals, such as magnesium, calcium, strontium and barium, preferably magnesium and calcium, particularly preferably magnesium, rare earth metals, such as scandium, yttrium, lanthanum, cerium, praseodymium and neodymium, preferably scandium, yttrium, lanthanum and cerium, particularly preferably lanthanum and cerium, or mixtures thereof.

The shaped bodies can then be dried, and optionally calcined, at a temperature of from 100 to 400° C., preferably 100 to 300° C., for example under a nitrogen, argon or air atmosphere. Preferably, the shaped bodies are first dried at 100 to 150° C. and then calcined at 200 to 400° C.

The conversion of hydrogen chloride in a single pass can be limited to 15 to 90%, preferably 30 to 90%, particularly preferably 40 to 90%. Some or all of the unreacted hydrogen chloride can be recycled into the catalytic hydrogen chloride oxidation after being separated off. The volume ratio of hydrogen chloride to oxygen at the reactor intake is, in particular, 1:1 to 20:1, preferably 1:1 to 8:1, particularly preferably 1:1 to 5:1.

In the case of the use of several reactors connected in series, addition of the oxygen before the first reactor and distributed addition of the hydrogen chloride over the various reactors in a particularly preferred process, the volume ratio of hydrogen chloride to oxygen at the intake into the first reactor is 1:8 to 2:1, preferably 1:5 to 2:1, particularly preferably 1:5 to 1:2.

In a last step, the chlorine formed is separated off. The separating off step conventionally comprises several stages, namely the separating off and optionally recycling of unreacted hydrogen chloride from the product gas stream of the catalytic hydrogen chloride oxidation, drying of the stream obtained, which essentially contains chlorine and oxygen, and separating off of chlorine from the dried stream.

Unreacted hydrogen chloride and the steam formed can be separated off by condensing aqueous hydrochloric acid from the product gas stream of the hydrogen chloride oxidation by cooling. Hydrogen chloride can also be absorbed in dilute hydrochloric acid or water.

The invention will now be described in further detail with reference to the following non-limiting examples.

### EXAMPLES

### Example 1

FIG. 1 shows a hydrogen chloride oxidation process that utilizes a part of the heat content of the product gases of the reaction to heat the feed stream to the reactor. Referring to FIG. 1, 55.5 kg/h of HCl gas having a composition of 1.1 wt. % N₂, 0.2 wt. % CO, 1.8 wt. % CO₂, 0.2 wt. % monochlorobenzene and 0.2 wt. % ortho-dichlorobenzene are compressed from ambient pressure to 6.5 bar abs. in a compressor 1. 10.9 kg/h of oxygen are then admixed under pressure with the compressed HCl gas.

After feeding in of an oxygen-containing gas stream recycled from the process, the gas mixture is heated to 150° C. in a pre-heater 2. Thereafter, it arrives at a next pre-heater 3, in which further preheating takes place by using the heat content of the product gases after the reactor 5. The gas mixture thereby heats up to 260° C. and at the same time the product gases cool down to approx. 250° C.

The reactor intake temperature is then adjusted to about 280° C. in a further pre-heater 4.

Then the gas mixture flows through reactor 5 where it is partly converted to chlorine and steam. The reactor 5 is filled with calcined supported ruthenium chloride as the catalyst and is operated adiabatically.

After flowing through the pre-heater 3, the product gases are cooled in a first after-cooler 6 to a temperature of less than 250° C. but still above the dew point.

In the second after-cooler 7, the temperature is lowered to below the dew point and adjusted to a value of approx. 100° C.

The water formed and unreacted HCl are then removed from the gas stream as hydrochloric acid in an absorption column 8. In order to remove the heat of absorption thereby released, the column is provided in its lower part with a pumped circulation in which a cooler is installed. To wash all the HCl out of the gas stream, 20 liters/h of fresh water 9 are introduced at the top of the column.

To improve the absorption effect, it is advantageous to use, instead of a single absorption column as shown in FIG. 1, two or three apparatuses connected in series (not shown), into which the gas stream and the absorption liquid are led in counter-current.

To minimize the fresh water stream, it is furthermore advantageous to employ trays instead of a random packing or instead of a structured packing at the top of the last absorption column (not shown). The fresh water stream can thereby be adjusted according to the absorption task and does not have to depend on the required liquid load of the random packing or of the structured packing.

After removal of the HCl and the majority of the water of reaction, the gas stream arrives in a drying column 10 in which the residual water is removed down to traces with sulfuric acid. Here also, a cooled pumped circulation is installed in the lower part of the column to remove the heat of absorption. In order to achieve as good as possible a drying result, 2 liters/h of a 96 wt. % strength sulfuric acid are introduced at the top of the column. Passing through the column, the sulfuric acid becomes diluted, and it is discharged as dilute sulfuric acid from the column bottoms.

Here also, for the same reasons as in the absorption column 8 it is particularly advantageous to employ trays instead of a random packing or a structured packing in the upper part of the column.

The gas stream is then compressed to 12 bar abs. in the compressor 11 and cooled to about 40° C. in the cooler 12.

In the following condenser 13, the temperature is lowered to −10° C. in order to condense some of the chlorine contained in the gas stream. Some of the carbon dioxide present in the gas stream thereby co-condenses, so that the quality of the liquid chlorine is not adequate for its further use.

For this reason, the carbon dioxide is stripped out in the column 14 equipped with trays, and the liquid chlorine, which is largely free from carbon dioxide, leaves the column. Some of this chlorine is vaporized in the reboiler 15 of the column 14 and is fed to this as stripping vapor.

The residual chlorine is vaporized completely in the evaporator 16 and fed into a pipeline system.

At the top of the column 14, the gas stream is passed though an overheads condenser 17 and cooled to −40° C. or lower. Further chlorine and carbon dioxide thereby condense and are recycled into the column 14.

The remaining residual gas essentially contains the unreacted oxygen and is therefore recycled back to before the reactor 5. Since it has a temperature of −40° C. coming from the overheads condenser 17, it must first be heated. For this, it flows through the heat exchanger 18 and is heated to ambient temperature. Some of the residual gas is then led out of the process in order to purge inert substances. Thereafter, washing is carried out in the column 19. The washing is carried out with 5 liters/h of water, which is trickled into the column 19 in counter-current to the gas. Catalyst poisons which result from the drying with sulfuric acid are thereby washed out. The purified residual gas is now recycled into the process.

### Example 2

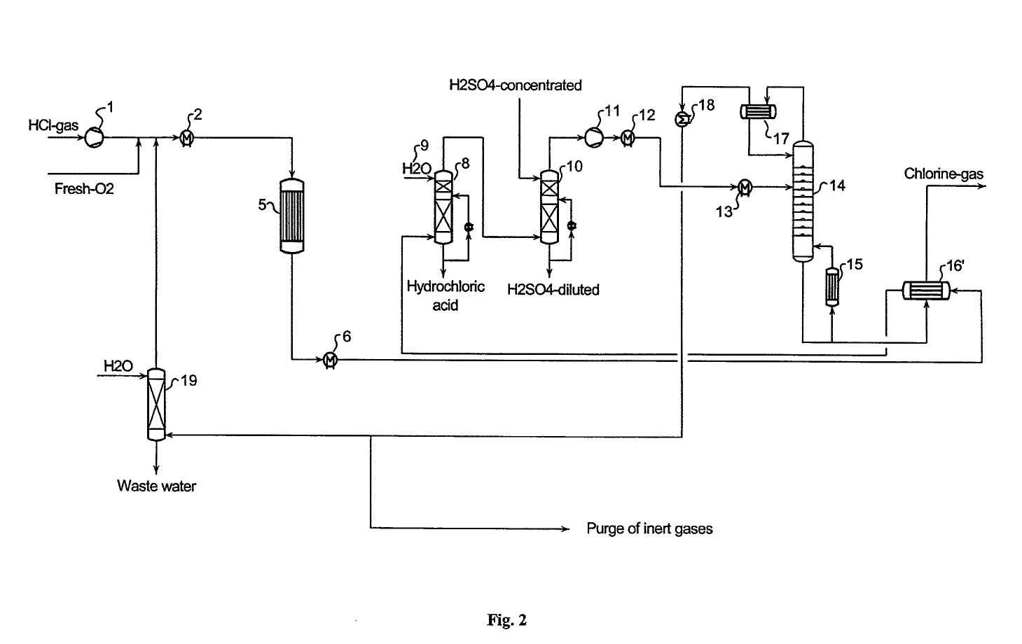

FIG. 2 shows a hydrogen chloride oxidation process where a part of the heat content of the product gases of the reaction is utilized to evaporate a product stream. Referring to FIG. 2, 40 kg/h of HCl gas having the composition as in Example 1 are compressed from ambient pressure to 6.5 bar abs. in a compressor 1.8 kg/h of oxygen are then admixed under pressure with the compressed HCl gas.

After feeding in of an oxygen-containing gas stream recycled from the process, the gas mixture is heated to 280° C. in a heater 2.

Then the gas mixture flows through reactor 5 where it is partly converted to chlorine and steam. The reactor 5 is filled with calcined supported ruthenium chloride as the catalyst and is operated adiabatically.

The product gases are cooled in an after-cooler 6 to a temperature of less than 250° C. but still above the dew point.

Instead of the second after-cooler 7 (see example 1), the product gases flow through recuperator 16′ and are further cooled. On the other side of recuperator 16′ the liquid chlorine evaporates, thus utilizing a part of the heat content of the product gases. As the heat exchanged in this apparatus is not sufficient to lower the temperature of the product gases to below the dew point, the gases are then led to the absorption column 8 with a temperature above the dew point of approx. 150° C. The water formed and unreacted HCl are then removed from the gas stream as hydrochloric acid in an absorption column 8. In order to remove the heats of condensation and absorption thereby released, the column is provided in its lower part with a pumped circulation in which a cooler is installed. To wash all the HCl out of the gas stream, 15 liters/h of fresh water 9 are introduced at the top of the column.

To improve the absorption effect, it is advantageous to use, instead of a single absorption column as shown in FIG. 2, two or three apparatuses connected in series (not shown), into which the gas stream and the absorption liquid are led in counter-current.

To minimize the fresh water stream, it is furthermore advantageous to employ trays instead of a random packing or instead of a structured packing at the top of column 8 or of the last absorption column of a series of columns (not shown). The fresh water stream can thereby be adjusted according to the absorption task and does not have to depend on the required liquid load of the random packing or of the structured packing.

After removal of the HCl and the majority of the water of reaction, the gas stream arrives in a drying column 10 in which the residual water is removed down to traces with sulfuric acid. Here also, a cooled pumped circulation is installed in the lower part of the column to remove the heat of absorption. In order to achieve as good as possible a drying result, 2 liters/h of a 96 wt. % strength sulfuric acid are introduced at the top of the column. Passing through the column, the sulfuric acid becomes diluted, and it is discharged as dilute sulfuric acid from the column bottoms.

Here also, for the same reasons as in the absorption column 8 it is particularly advantageous to employ trays instead of a random packing or a structured packing in the upper part of the column.

The gas stream is then compressed to 12 bar abs. in the compressor 11 and cooled to about 40° C. in the cooler 12.

In the following condenser 13, the temperature is lowered to −10° C. in order to condense some of the chlorine contained in the gas stream. Some of the carbon dioxide present in the gas stream thereby co-condenses, so that the quality of the liquid chlorine is not adequate for its further use.

For this reason, the carbon dioxide is stripped out in the column 14 equipped with trays, and the liquid chlorine, which is largely free from carbon dioxide, leaves the column. Some of this chlorine is vaporized in the reboiler 15 of the column 14 and is fed to this as stripping vapor.

The residual chlorine is vaporized completely in the recuperator 16′ as described above and fed into a pipeline system for its further use.

At the top of the column 14, the gas stream is passed through an overheads condenser 17 and cooled to −40° C. or lower. Further chlorine and carbon dioxide thereby condense and are recycled into the column 14.

The remaining residual gas essentially contains the unreacted oxygen and is therefore recycled back to before the reactor 5. Since it has a temperature of −40° C. coming from the overheads condenser 17, it must first be heated. For this, it flows through the heat exchanger 18 and is heated to ambient temperature. Some of the residual gas is then led out of the process in order to purge inert substances. Thereafter, washing is carried out in the column 19. The washing is carried out with 4 liters/h of water, which is trickled into the column 19 in counter-current to the gas. Catalyst poisons which result from the drying with sulfuric acid are thereby washed out. The purified residual gas is now recycled into the process.

### Example 3

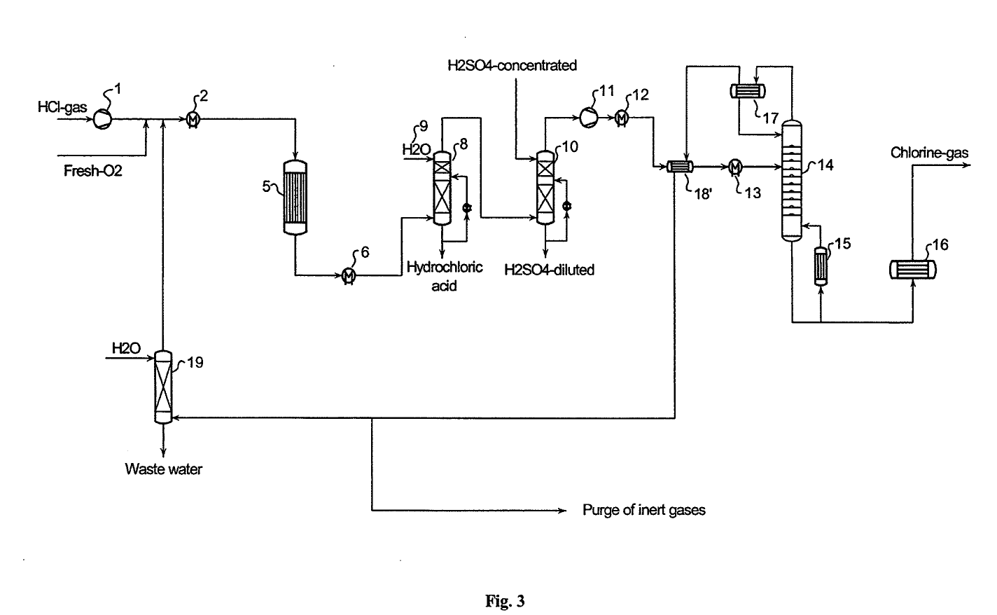

FIG. 3 depicts a hydrogen chloride oxidation process where two process streams are linked for heat recovery. Referring to FIG. 3, HCl gas as in Example 2 is compressed in compressor 1 to a pressure of 6.5 bar abs. and then admixed with 8 kg/h of oxygen under pressure.

After feeding in of an oxygen-containing gas stream recycled from the process, the gas mixture is heated to 280° C. in a heater 2.

Then the gas mixture flows through reactor 5 where it is partly converted to chlorine and steam. The reactor 5 is filled with calcined supported ruthenium chloride as the catalyst and is operated adiabatically.

The product gases are cooled in an after-cooler 6 below the dew point to approx. 100° C.

The water formed and unreacted HCl are then removed from the gas stream as hydrochloric acid in an absorption column 8. In order to remove the heat of absorption thereby released, the column is provided in its lower part with a pumped circulation in which a cooler is installed. To wash all the HCl out of the gas stream, 15 liters/h of fresh water 9 are introduced at the top of the column.

To improve the absorption effect, it is advantageous to use, instead of a single absorption column as shown in FIG. 3, two or three apparatuses connected in series (not shown), into which the gas stream and the absorption liquid are led in counter-current.

To minimize the fresh water stream, it is furthermore advantageous to employ trays instead of a random packing or instead of a structured packing at the top of the last absorption column (not shown). The fresh water stream can thereby be adjusted according to the absorption task and does not have to depend on the required liquid load of the random packing or of the structured packing.

After removal of the HCl and the majority of the water of reaction, the gas stream arrives in a drying column 10 in which the residual water is removed down to traces with sulfuric acid. Here also, a cooled pumped circulation is installed in the lower part of the column to remove the heat of absorption. In order to achieve as good as possible a drying result, 2 liters/h of a 96 wt. % strength sulfuric acid are introduced at the top of the column. Passing through the column, the sulfuric acid becomes diluted, and it is discharged as dilute sulfuric acid from the column bottoms.

Here also, for the same reasons as in the absorption column 8 it is particularly advantageous to employ trays instead of a random packing or a structured packing in the upper part of the column.

The gas stream is then compressed to 12 bar abs. in the compressor 11 and cooled to about 40° C. in the cooler 12.

In the following recuperator 18′, the temperature is lowered to approx. 0° C. On the other side of the recuperator 18′ flows the cold residual gas from the overheads condenser 17 and is heated at the same time to ambient temperature. After that, the gas stream is led to condenser 13 and its temperature is lowered to −10° C. in order to condense some of the chlorine contained in it. Some of the carbon dioxide present in the gas stream thereby co-condenses, so that the quality of the liquid chlorine is not adequate for its further use.

For this reason, the carbon dioxide is stripped out in the column 14 equipped with trays, and the liquid chlorine, which is largely free from carbon dioxide, leaves the column. Some of this chlorine is vaporized in the reboiler 15 of the column 14 and is fed to this as stripping vapor.

The residual chlorine is vaporized completely in the evaporator 16 and fed into a pipeline system.

At the top of the column 14, the gas stream is passed through an overheads condenser 17 and cooled to −40° C. or lower. Further chlorine and carbon dioxide thereby condense and are recycled into the column 14.

The remaining residual gas essentially contains the unreacted oxygen and is therefore recycled back to before the reactor 5. Since it has a temperature of −40° C. coming from the overheads condenser 17, it must first be heated. For this, it flows through the recuperator 18′ as described above and is heated to ambient temperature. This has the additional benefit for the residual gas stream that no heat transfer medium, such as, for example, water, which could freeze and therefore damage the apparatus required for heating, has to be employed for its heating. Alternatively, the recuperator 18′ can also be installed after the condenser 13 (not shown) and therefore effect further condensation of chlorine.

Some of the residual gas is then led out of the process in order to purge inert substances. Thereafter, washing is carried out in the column 19. The washing is carried out with 4 liters/h of water, which is trickled into the column 19 in counter-current to the gas. Catalyst poisons which result from the drying with sulfuric acid are thereby washed out. The purified residual gas is now recycled into the process.

### Example 4

FIG. 4 shows a highly heat integrated hydrogen chloride oxidation process where in accordance with Example 1 a part of the heat content of the product gases of the reaction is utilized to heat the feed stream to the reactor. A further part of this heat content is employed for the evaporation of a product stream and for operating a column reboiler. For this heat recovery, a heat transfer medium is used. Beyond this, two internal process streams are heat integrated according to Example 3. Referring to FIG. 4, 55.5 kg/h of HCl gas composed as in Example 1 are compressed in compressor 1 to 6.5 bar abs. and then admixed with 10.9 kg/h of oxygen under pressure.

After feeding in of an oxygen-containing gas stream recycled from the process, the gas mixture is heated to 150° C. in a pre-heater 2. Thereafter, it arrives at a next pre-heater 3, in which further preheating takes place by using the heat content of the product gases after the reactor 5. The gas mixture thereby heats up to 260° C. and at the same time the product gases cool down to approx. 250° C.

The reactor intake temperature is then adjusted to about 280° C. in a further pre-heater 4.

Then the gas mixture flows through reactor 5 where it is partly converted to chlorine and steam. The reactor 5 is filled with calcined supported ruthenium chloride as the catalyst and is operated adiabatically.

After flowing through the pre-heater 3, the product gases are cooled in a first after-cooler 6 to a temperature of less than 250° C. but still above the dew point. In the second after-cooler 7′, the temperature is lowered to below the dew point and adjusted to a value of approx. 100° C. However, the heat exchanger 7′ here is equipped with a heat transfer medium circulation. Water, steam, thermal oils or other suitable fluids are possible as the heat transfer fluid. The heat transfer fluid absorbs the heat released in the heat exchanger 7′ on cooling of the product gas and releases it both to the evaporator 16′ and to the reboiler 15′ of the column 14. The heat transfer medium is then transported back to the after-cooler 7′ in order to absorb heat. A large portion of the heat content of the product gases is used in this manner.

The water formed and unreacted HCl are then removed from the gas stream as hydrochloric acid in an absorption column 8. In order to remove the heat of absorption thereby released, the column is provided in its lower part with a pumped circulation in which a cooler is installed. To wash all the HCl out of the gas stream, 20 liters/h of fresh water 9 are introduced at the top of the column.

To improve the absorption effect, it is advantageous to use, instead of a single absorption column as shown in FIG. 4, two or three apparatuses connected in series (not shown), into which the gas stream and the absorption liquid are led in counter-current.

To minimize the fresh water stream, it is furthermore advantageous to employ trays instead of a random packing or instead of a structured packing at the top of the last absorption column (not shown). The fresh water stream can thereby be adjusted according to the absorption task and does not have to depend on the required liquid load of the random packing or of the structured packing.

After removal of the HCl and the majority of the water of reaction, the gas stream arrives in a drying column 10 in which the residual water is removed down to traces with sulfuric acid. Here also, a cooled pumped circulation is installed in the lower part of the column to remove the heat of absorption. In order to achieve as good as possible a drying result, 2 liters/h of a 96 wt. % strength sulfuric acid are introduced at the top of the column. Passing through the column, the sulfuric acid becomes diluted, and it is discharged as dilute sulfuric acid from the column bottoms.

Here also, for the same reasons as in the absorption column 8 it is particularly advantageous to employ trays instead of a random packing or a structured packing in the upper part of the column.

The gas stream is then compressed to 12 bar abs. in the compressor 11 and cooled to about 40° C. in the cooler 12.

In the following recuperator 18′, the temperature is lowered to approx. 0° C. On the other side of the recuperator 18′ flows the cold residual gas from the overheads condenser 17 and is heated at the same time to ambient temperature. After that, the gas stream is led to condenser 13 and its temperature is lowered to −10° C. in order to condense some of the chlorine contained in it. Some of the carbon dioxide present in the gas stream thereby co-condenses, so that the quality of the liquid chlorine is not adequate for its further use.

For this reason, the carbon dioxide is stripped out in the column 14 equipped with trays, and the liquid chlorine, which is largely free from carbon dioxide, leaves the column. Some of this chlorine is vaporized in the reboiler 15′ of the column 14 and is fed to this as stripping vapor. The reboiler 15′ is operated, as described above, with a heat transfer medium that is utilized to recover a part of the heat of the product gases.

The residual chlorine is vaporized completely in the evaporator 16′ and fed into a pipeline system. Evaporator 16′ is also operated, as described above, with a heat transfer medium to recover another part of the heat of the product gases.

At the top of the column 14, the gas stream is passed through the overheads condenser 17 and cooled to −40° C. or lower. Further chlorine and carbon dioxide thereby condense and are recycled into the column 14.

The remaining residual gas essentially contains the unreacted oxygen and is therefore recycled back to before the reactor 5. Since it has a temperature of −40° C. coming from the overheads condenser 17, it must first be heated. For this, it flows through the recuperator 18′ as described above and is heated to ambient temperature. This has the additional benefit for the residual gas stream that no heat transfer medium, such as, for example, water, which could freeze and therefore damage the apparatus required for heating, has to be employed for its heating. Alternatively, the recuperator 18′ can also be installed after the condenser 13 (not shown) and therefore effect further condensation of chlorine.

Some of the residual gas is then led out of the process in order to purge inert substances. Thereafter, washing is carried out in the column 19. The washing is carried out with 5 liters/h of water, which is trickled into the column 19 in counter-current to the gas. Catalyst poisons which result from the drying with sulfuric acid are thereby washed out. The purified residual gas is now recycled into the process.

The heat integration measures described mean that this variant is considerably more energy-efficient than in Comparison Example 5 and also all the other examples.

### Comparative Example 5

FIG. 5 shows a hydrogen chloride oxidation process with no heat recovery at all and is added for comparison. Referring to FIG. 5, 76.9 kg/h of HCl gas having the composition as in Example 1 are compressed to 6.5 bar abs. in compressor 1 and then mixed with 15.1 kg/h of oxygen under pressure.

After feeding in of an oxygen-containing gas stream recycled from the process, the gas mixture is heated to 280° C. in a heater 2.

Then the gas mixture flows through reactor 5 where it is partly converted to chlorine and steam. The reactor 5 is filled with calcined supported ruthenium chloride as the catalyst and is operated adiabatically.

The product gases are cooled in an after-cooler 6 below the dew point to approx. 100° C.

The water formed and unreacted HCl are then removed from the gas stream as hydrochloric acid in an absorption column 8. In order to remove the heat of absorption thereby released, the column is provided in its lower part with a pumped circulation in which a cooler is installed. To wash all the HCl out of the gas stream, 30 liters/h of fresh water 9 are introduced at the top of the column.

To improve the absorption effect, it is advantageous to use, instead of a single absorption column as shown in FIG. 5, two or three apparatuses connected in series (not shown), into which the gas stream and the absorption liquid are led in counter-current.

To minimize the fresh water stream, it is furthermore advantageous to employ trays instead of a random packing or instead of a structured packing at the top of the last absorption column (not shown). The fresh water stream can thereby be adjusted according to the absorption task and does not have to depend on the required liquid load of the random packing or of the structured packing.

After removal of the HCl and the majority of the water of reaction, the gas stream arrives in a drying column 10 in which the residual water is removed down to traces with sulfuric acid. Here also, a cooled pumped circulation is installed in the lower part of the column to remove the heat of absorption. In order to achieve as good as possible a drying result, 3 liters/h of a 96 wt. % strength sulfuric acid are introduced at the top of the column. Passing through the column, the sulfuric acid becomes diluted, and it is discharged as dilute sulfuric acid from the column bottoms.

Here also, for the same reasons as in the absorption column 8 it is particularly advantageous to employ trays instead of a random packing or a structured packing in the upper part of the column.

The gas stream is then compressed to 12 bar abs. in the compressor 11 and cooled to about 40° C. in the cooler 12.

In the following condenser 13, the temperature is lowered to −10° C. in order to condense some of the chlorine contained in the gas stream. Some of the carbon dioxide present in the gas stream thereby co-condenses, so that the quality of the liquid chlorine is not adequate for its further use.

For this reason, the carbon dioxide is stripped out in the column 14 equipped with trays, and the liquid chlorine, which is largely free from carbon dioxide, leaves the column. Some of this chlorine is vaporized in the reboiler 15 of the column 14 and is fed to this as stripping vapor.

The residual chlorine is vaporized completely in the evaporator 16 and fed into a pipeline system.

At the top of the column 14, the gas stream is passed through the overheads condenser 17 and cooled to −40° C. or lower. Further chlorine and carbon dioxide thereby condense and are recycled into the column 14.

The remaining residual gas essentially contains the unreacted oxygen and is therefore recycled back to before the reactor 5. Since it has a temperature of −40° C. coming from the overheads condenser 17, it must first be heated. For this, it flows through the heat exchanger 18 and is heated to ambient temperature. Some of the residual gas is then led out of the process in order to purge inert substances. Thereafter, washing is carried out in the column 19. The washing is carried out with 7 liters/h of water, which is trickled into the column 19 in counter-current to the gas. Catalyst poisons which result from the drying with sulfuric acid are thereby washed out. The purified residual gas is now recycled into the process.

The energy consumption is the highest in this process, since no heat is integrated at all.

It will be appreciated by those skilled in the art that changes could be made to the embodiments described above without departing from the broad inventive concept thereof It is understood, therefore, that this invention is not limited to the particular embodiments disclosed, but it is intended to cover modifications within the spirit and scope of the present invention as defined by the appended claims.

What is claimed is:

1. A process comprising: providing a reaction gas comprising hydrogen chloride; and subjecting the reaction gas to catalytic oxidation with an oxygen-containing gas to form a product gas comprising chlorine and water, wherein at least a portion of the heat content of the product gas is used to heat at least a portion of one or both of the reaction gas and the oxygen-containing gas.

2. A process comprising: providing a reaction gas comprising hydrogen chloride; subjecting the reaction gas to catalytic oxidation with an oxygen-containing gas to form a product gas comprising chlorine and water, separating chlorine from the product gas by liquification of the chlorine and removal of any inert gases present, and subsequent vaporization of the chlorine, wherein at least a portion of the heat content of the product gas is used for vaporization of the liquefied chlorine.

3. A process comprising: providing a reaction gas comprising hydrogen chloride; subjecting the reaction gas to catalytic oxidation with an oxygen-containing gas to form a product gas comprising chlorine and water, separating chlorine from the product gas by liquification of the chlorine, the liquid chlorine comprising carbon dioxide, and subsequently vaporizing at least a portion of the carbon dioxide out of the liquefied chlorine, wherein at least a portion of the heat content of the product gas is used for vaporization of the carbon dioxide.

4. A process comprising: providing a reaction gas comprising hydrogen chloride; subjecting the reaction gas to catalytic oxidation with an oxygen-containing gas to form a product gas comprising chlorine and water, separating chlorine from the product gas by liquification of the chlorine and removal of any inert gases present, wherein at least a portion of the inert gases removed are used for precooling the product gas entering the chlorine liquification.

5. The process according to claim 1, further comprising after the oxidation reaction, separating chlorine from the product gas by liquification of the chlorine and removal of any inert gases present and subsequent vaporization of the chlorine, wherein at least a portion of the heat content of the product gas is used for vaporization of the liquefied chlorine.

6. The process according to claim 1, further comprising after the oxidation reaction, separating chlorine from the product gas by liquification of the chlorine, the liquid chlorine comprising carbon dioxide, and subsequently vaporizing at least a portion of the carbon dioxide out of the liquefied chlorine, wherein at least a portion of the heat content of the product gas is used for vaporization of the carbon dioxide.

7. The process according to claim 1, further comprising after the oxidation reaction, separating chlorine from the product gas by liquification of the chlorine and removal of any inert gases present, wherein at least a portion of the inert gases removed are used for precooling the product gas entering the chlorine liquification.

8. The process according to claim 2, wherein the liquid chlorine comprises carbon dioxide, and wherein the process further comprises vaporizing at least a portion of the carbon dioxide out of the liquefied chlorine, wherein at least a portion of the heat content of the product gas is used for vaporization of the carbon dioxide.

9. The process according to claim 2, wherein at least a portion of the inert gases removed are used for precooling the product gas entering the chlorine liquification.

10. The process according to claim 3, wherein at least a portion of the inert gases removed are used for precooling the product gas entering the chlorine liquification.
